(19) United States
(12) Patent Application Publication
(10) Pub. No.: US 2005/0016372 A1
(43) Pub. Date: Jan. 27, 2005

(54) Vessel immobiliser projectile

(76) Inventor: Anthony David Kilvert, Brighton (GB)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/488,381

(22) PCT Filed: Aug. 30, 2002
(86) PCT No.: PCT/GB02/03970

(30) Foreign Application Priority Data
Aug. 30, 2001 (GB) 0121011.1

(51) Int. Cl. B64D 1/04; B63B 38/00

(52) U.S. Cl. 89/1.34; 89/1.11; 114/382

(57) ABSTRACT

A ship 1 has a compressed gas launcher 3 equipped with a projectile 4, from which a boom arrangement 5 deploys. The deployed boom arrangement has three individual booms 6 in a star format, with fouling wires 7 extending along the booms. The individual booms extend from a hub 8. An equilateral triangle set of stays 9 is provided to extend between adjacent pairs of booms, to which they are attached via swivels 10 attached to close to the distal ends of the booms. The proximal ends 17 of the boom rolls are brought together at the hub 8, which has a four way connector 20 having union nuts 21. These clamp the main, inner, polyethylene, lay-flat tubes 22 of the booms to three of the ways 23 of the connector which are equi-angularly spaced. Stiffening strips 24 of plastics strapping material meet above the hub, are welded 25 to each other and are held to the inner tubes by thinner, outer tubes 26.

The present invention relates to a vessel immobiliser projectile.

It is known to project a wire into the path of a vessel, to immobilise the vessel by fouling its propeller, as in a pirate attack.

In earlier International Patent Application No WO 99/30966, there was proposed:

An immobiliser device for a sea-faring vessel having a housing in which is stowed, in an unextended state, a length of fouling wire which, in use, is designed to foul the propeller and/or motor of a target vessel. The wire is automatically ejected from the housing on or soon after contact with the water. The wire may be ejected by being attached to a projectile that is propelled from the housing or may be wrapped around an inflatable member. The device allows a first vessel to take action to prevent the approach of a second threatening vessel or to immobilise a fleeing vessel.

It should be noted that as used herein the term “projectile” means the vehicle, typically launched from a compressed air launcher, which carries the vessel immobiliser from a ship under attack or other launch platform into the path of the vessel to be immobilised.

Difficulties have been experienced in deploying the inflatable member to extend the wire over a sufficient area of the sea to form an effective deterrent.

The object of the present invention is to improve deployment of the inflatable member of a vessel immobiliser, and in particular to improve deployment of a plurality of such members at pre-determined orientations with respect to each other. The improved deployment is sought by improving the directional stability of the inflatable member.

According to the invention there is provided a vessel immobiliser projectile having a casing and a vessel immobiliser carried in the casing, the vessel immobiliser comprising:
at least one inflatable member in the form of an inflatable roll,
means for inflating the inflatable member, and
propeller fouling members extending along and/or from the inflatable member,
   wherein:
the inflatable elongate member is a tube having one or more elongate stiffening members for providing the tube with directional stability on inflation.

The directional stability is provided not only in enhanced stiffness against bending laterally of the inflated member's extent on the surface of the sea—or other expanse of water—but also in directing initial unrolling in a desired direction and in maintaining such direction as the tube continues to un-roll.

Preferably the vessel immobiliser has a plurality of stiffened inflatable members, each stiffened by at least one stiffening member, in which case, the immobiliser preferably includes means for initially deploying the inflatable members at a pre-determined orientation with respect to each other.

The initial pre-determined orientation means can comprise either or both of:
an interconnection of the stiffening members of the inflatable members at a hub, the interconnection being configured for directing the stiffening members in a desired direction and
lines between points on the inflatable members remote from the hub for spacing the members at their relative orientation.
   Conveniently this orientation will be equi-angular spacing. The stiffening members interconnection can be by welding, clipping, riveting or like fixture method.

Preferably the hubs will include passages for distributing inflation gas to each inflatable member. These passages can incorporate individual non-return valves to avoid deflation of the entire immobiliser if one member is punctured.

The elongate tubes are preferably of polyethylene or the like lay-flat plastics material tube. The stiffening members can be thicker and narrower strips of the same or similar material. It is envisaged that the strips may be integrally extruded with the tube. Alternatively they can be attached to the tube. In this case, the strips can be of intrinsically stiffer material, such as fibre reinforced plastics strapping material. The straps can be attached directly by adhesive. However, it is preferred to accommodate the strips in elongate pockets along the length of the tube. This allows for relative longitudinal movement of the strips and the pockets/tubes as may occur on rolling up of the tubes. The pockets may be individual for individual strips. They can be formed by welding or adhesively securing thin strips of tube material onto the tubes. Alternatively, the pockets can be narrow lay-flat tubes secured along the length of the main tubes. In another alternative, the pockets may be provided between the main tubes and outer (or inner) additional sleeves enclosing (or enclosed within) the main sleeve. Yet another alternative is for the stiffening strips to be provided inside their tubes, either in an internal pocket or between the main tube and an internal tube or indeed loose in the main tube.

A single stiffening strip may be provided for each tube. However in one preferred embodiment three are provided, one on one lay flat side and two on the other, the one fitting between the two when the tubes are flat and rolled for packing in the projectile.

Conveniently, the means for inflating the tubes comprises a gas cylinder as used in inflatable devices such as life jackets or rafts. Typically, the gas can be released by a soluble member as is known in the inflatable device art.

In accordance with an important preferred feature, means is provided for expelling the tube rolls from the casing. Preferably this is activated by the inflation means extending an actuator to expel the tubes. The actuator can be a piston and cylinder device. In the preferred embodiment it is a diaphragm device having a limited stroke.

To help understanding of the invention, a specific embodiment thereof will now be described by way of example and with reference to the accompanying drawings, in which:

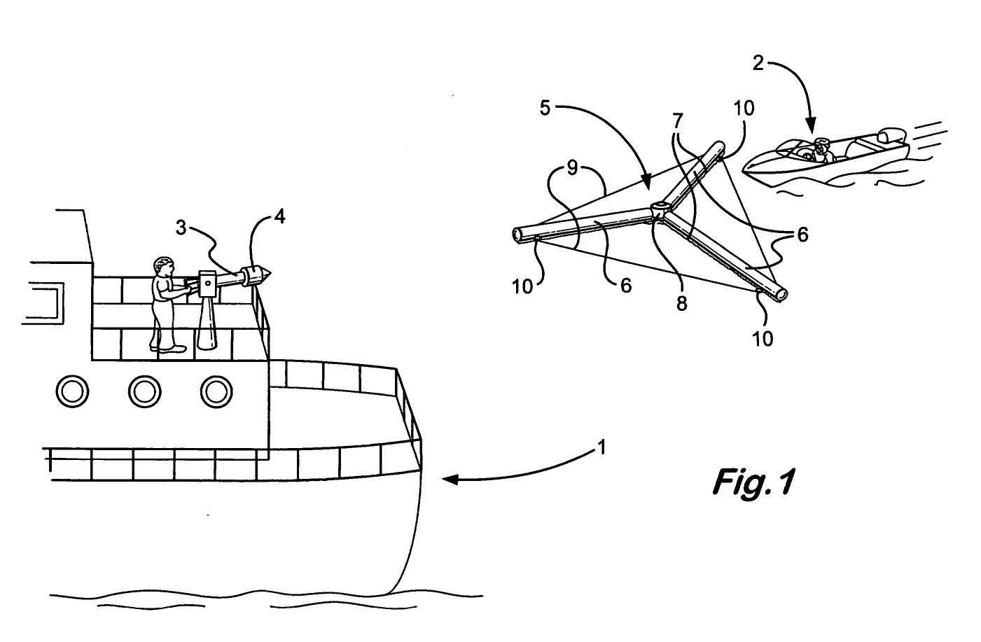

FIG. 1 is a perspective view of a vessel immobiliser of the invention in use;

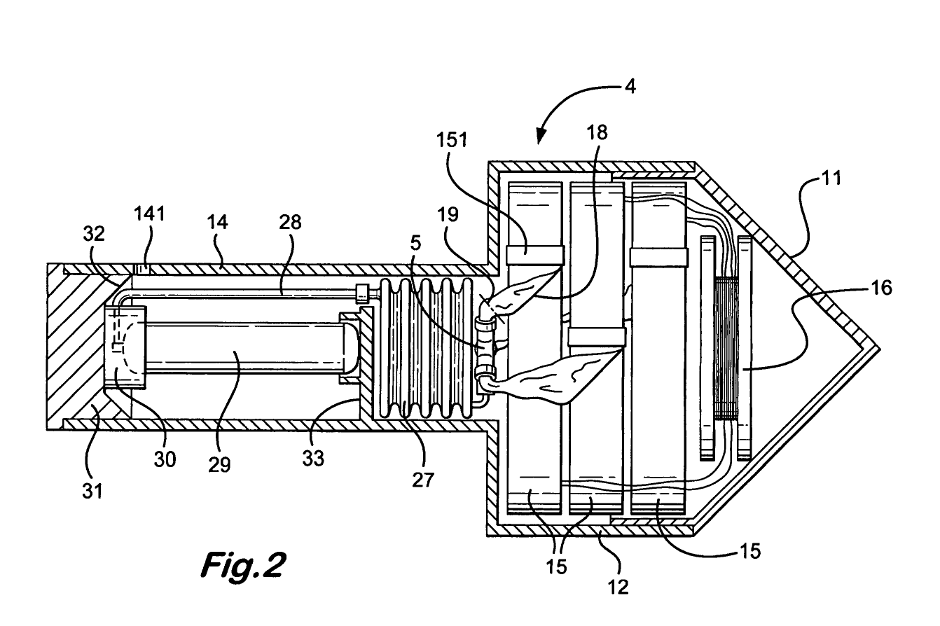

FIG. 2 is a central cross-sectional view of a vessel immobiliser projectile according to the invention;

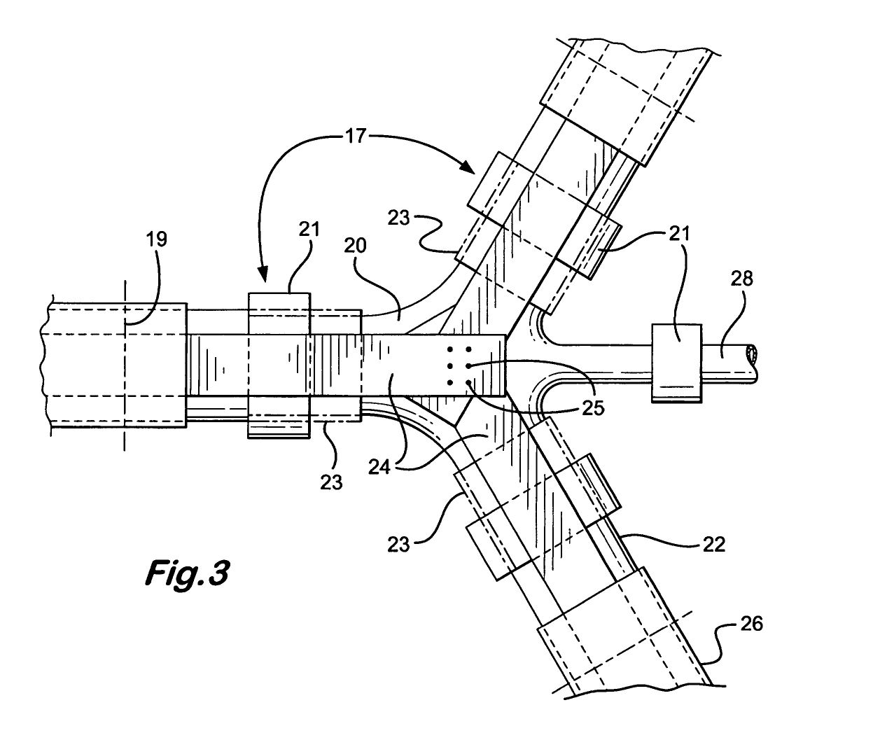

FIG. 3 is a plan view of a hub of the immobiliser after ejection from the projectile;

FIG. 4 is a side view of one boom roll of the immobiliser extends from the hub;

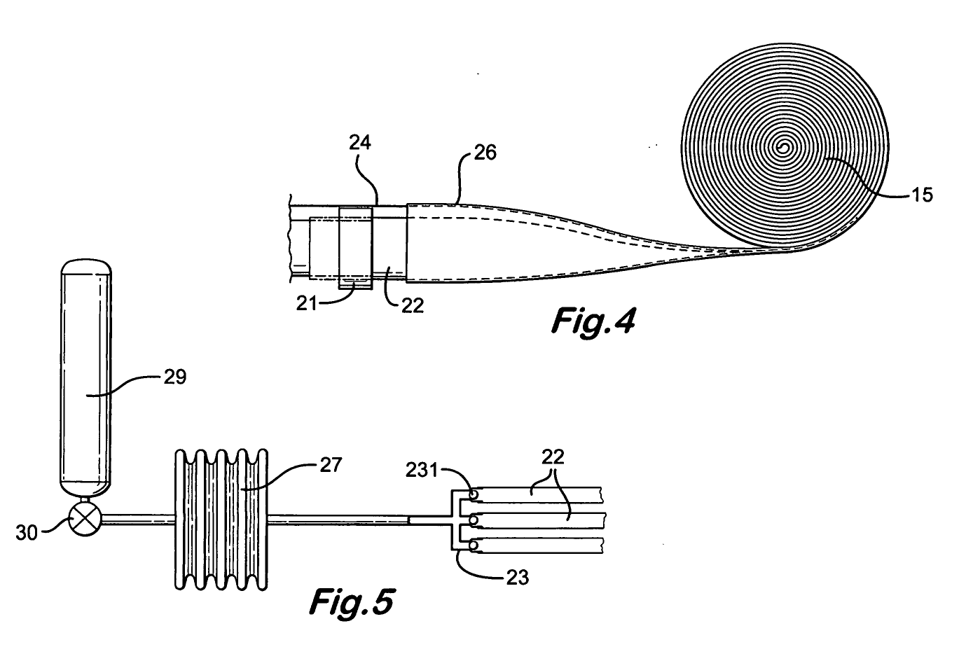

FIG. 5 is a pneumatic diagram of the immobiliser;

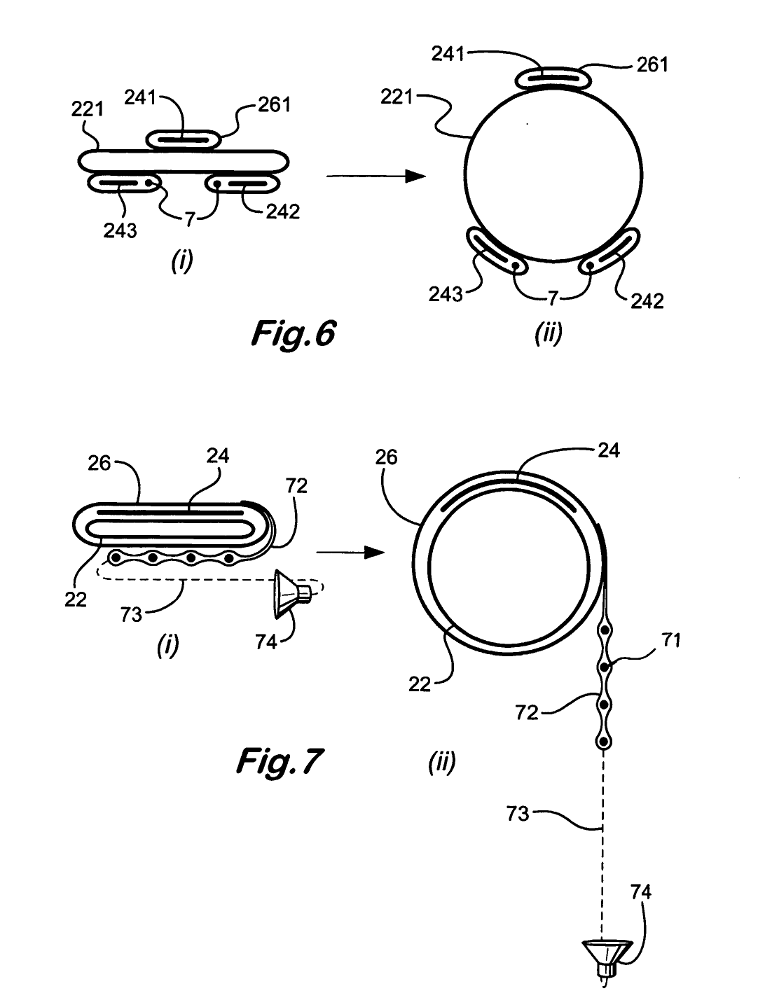

FIG. 6 is a cross-sectional side view of one varied boom of the immobiliser, showing in (i.) its lay-flat state and (ii.) its inflated state; and

FIG. 7 is a similar pair of cross-sections of another varied boom.

Referring first to FIG. 1 of the drawings, a ship 1 is there shown with a pirate boat 2 threatening to board it. The ship is provided with a compressed gas launcher 3 of the type suitable for launching breeches buoy lines and the like. The launcher is equipped with a projectile 4, from which a boom arrangement 5 deploys. The Figure shows one set of booms deployed and another projectile ready for launching if necessary. The deployed set has three individual booms 6 in a star format, with fouling wires 7 extending along the booms. The individual booms extend from a hub 8. An equilateral triangle set of stays 9 is provided to extend between adjacent pairs of booms, to which they are attached via swivels 10 attached to close to the distal ends of the booms.

As shown in FIG. 2, the projectile has a nose cone 11 in front of a large diameter body 12 to which a smaller diameter tail 14 is fixed. The nose cone is removable for deployment of the booms, which are contained in the large diameter body as three rolls 15, the rolls being temporarily retained by elastic bands 151. The stay wires 9 are wound on a spool 16 housed in front of the rolls, behind the nose cone.

The proximal ends 17 of the boom rolls are brought together at the hub, by folds 18 typically at 45° to turn them from extending circumferentially around the rolls 15 to longitudinally along inside the body and then further 90° folds 19 to turn them radially into the centre. The position of the folds 19 are shown in FIG. 3, although as shown therein the booms 6 have extended.

The hub 5 comprises a four way connector 20, having union nuts 21. These clamp the main, inner, polyethylene, lay-flat tubes 22 of the booms to three of the ways 23 of the connector which are equi-angularly spaced. Stiffening strips 24 of plastics strapping material meet above the hub and are welded 25 to each other. The strips 24 are held to the inner tubes, by thinner, outer tubes 26.

Referring back to FIG. 2, at the front end of the small diameter tail 14 is arranged an actuating bellows 27 of elastomeric material. Its forward end is connected to the fourth way of the connector 20 and its rear end is connected to a gas feed pipe 28. At the rear end of the tail is arranged a compressed carbon dioxide cylinder 29 with a gas release mechanism 30. The tail is apertured 141 to the environment, allowing water to access the release mechanism. The release mechanism is supported on an abutment 31 having faces 32 angled to direct water to the release mechanism as the projectile moves along the water on initial contact. In front of the cylinder 29 is a wall 33 against which the bellows can act. The projectile is fabricated of plastics material parts, conveniently of polypropylene, which are welded together, except for the nose cone 11, which is a press fit, sufficiently tight to remain in position during handling, yet able to be displaced as now described.

On launch, when the projectile is aimed at the sea in front of the attacking boat 2, the gas is released and fills the actuating bellows 27. These act against the wall 33. The gas cannot enter the booms which are rolled up. So the pressure causes the bladder to force the rolls out of the front body 12, pushing the nose cone off. As soon as the rolls are free, their bands 151 slip off under the inflation pressure. As the pressurised gas enters the rolls, they begin to unroll and deploy on the surface. The spools 16 fall away, unreeling the wires 9.

The projectile settles in the water with the tail down and the bellows up, providing buoyancy. The connector tends to adopt the position shown in FIG. 3, that is with the three ways extending horizontally. Thus the three welded together strips 24 extend horizontally, with equi-angular spacing. The boom rolls will tend to unroll, as shown in FIG. 4 in the directions determined by the equi-angular spacing. A particular advantage of the stiffening strips is that they tend to cause the rolls to remain coiled until the inflation pressure rolls out the under influence of the inflation of the inner tube right up to the coil. This is in contra-distinction to rolls without the stiffening members, in which the inflation gas has a tendency to seep along the coil and cause an uneven inflation without rapid rolling out from the hub.

As the booms extend, their final, relative orientation will be determined by the stay wires 9, which are connected to the distal ends of the booms when inflated by swivel rings 10, themselves secured to the outer tubes 26, at suitably reinforced positions.

The pneumatic arrangement of the immobiliser is shown in FIG. 5, which is self-explanatory, including non-return valves 231 in the three ways 23, to keep two of the booms inflated should the third become punctured.

In FIG. 6, a variant is shown, in which a narrow upper stiffening strip 241 is complemented by two lower strip 242, 243. Each has its own lay flat tube sleeve 261 adhesively secured to the main tube 221. The lower two tubes 261 include the fouling wires 7.

The variant of FIG. 7 has its fouling wires 71 held in a self-adhesive sandwich of “sticky-back” film 72, which is stuck to the outer tube. Additional fouling means in the form of short wires 73, with suckers 74 arranged to act as drogues to pull the wires 71, 73 into a jet propulsion inlet, are suspended from the bottom of the wires 71. When rolled up, the wires 71 are turned under the main boom tubes and the suckers are arranged at the end/side of the rolls. The strip 24 in this boom develops a cross-section curvature, akin to that of a U-channel beam, whereby the inflated tube benefits from increased stiffness.

The invention is not intended to be restricted to the details of the above described embodiment. For instance, more than one reinforcing strip may be provided along each boom, typically one on top and two below. The strips may be contained in longitudinal pockets as opposed to between the inner and the outer tubes of the booms. The strips may be integrated with the fouling wires as a compound strip having wires extending along each strip, individual wires being spaced across the strip. Securing these wires at the edge of the strips enhances the stiffness of the strips in their plane and laterally of their width. The inherent stiffness of the wires increases the resilient tendency of the inflatable members to unwind on deployment.

It is also envisaged that the device of the invention find other uses, particularly in life saving. In such application the fouling members would be dispensed with and a line be laid out from the launch vessel to the hub so that the person being rescued could be retrieved. A life buoy could be included in the projectile.

Further in place of the union nuts 21, double sided tape and cable ties can be used to connect the tubes 22 to the connector 20 in an air tight manner. The hub itself can be made up of three elbows connected to a common feed pipe extending down when the elbow outlets extend horizontally and radially. The bellows can be augmented by a helper spring for urging the nose cone from the body.

Whilst the fouling wires will normally be of metal, such as stainless steel, other materials such as Kevlar (RTM) able to foul propellers can be used instead.

1. A vessel immobiliser projectile having a casing and a vessel immobiliser carried in the casing, the vessel immobiliser comprising:
at least one inflatable member in the form of an inflatable roll,
means for inflating the inflatable member, and
propeller fouling members extending along and/or from the inflatable member,
wherein:
the inflatable member is a tube having one or more elongate stiffening members for providing the tube with directional stability on inflation.

2. A vessel immobiliser projectile as claimed in claim 1, wherein the immobiliser includes a plurality of the said stiffened inflatable members, each stiffened by at least one stiffening member.

3. A vessel immobiliser projectile as claimed in claim 2, wherein the immobiliser includes means for initially deploying the inflatable members at a pre-determined orientation with respect to each other.

4. A vessel immobiliser projectile as claimed in claim 3, wherein the initial predetermined orientation means comprises:
an interconnection of the stiffening members of the inflatable members at a hub, the interconnection being configured for directing the stiffening members in a desired direction.

5. A vessel immobiliser projectile as claimed in claim 3, wherein the initial pre-determined orientation means comprises:
lines between points on the inflatable members remote from the hub for spacing the members at their relative orientation.

6. A vessel immobiliser projectile as claimed in claim 5, wherein the initial predetermined orientation means is such that this orientation will be equi-angular spacing.

7. A vessel immobiliser projectile as claimed in claim 4, wherein the stiffening members interconnection is by means of one of the following group of interconnection means: welding, clipping, and riveting.

8. A vessel immobiliser projectile as claimed in claim 4, wherein the hubs include passages for distributing inflation gas to each inflatable member.

9. A vessel immobiliser projectile as claimed in claim 8, wherein the passages incorporate individual non-return valves to avoid deflation of the entire immobiliser if one member is punctured.

10. A vessel immobiliser projectile as claimed in claim 1, wherein the elongate tubes are of polyethylene or the like lay-flat plastics material tube.

11. A vessel immobiliser projectile as claimed in claim 10, wherein the stiffening members are thicker and narrower strips of the same or similar plastics material.

12. A vessel immobiliser projectile as claimed in claim 11, wherein the strips are integrally extruded with the tube.

13. A vessel immobiliser projectile as claimed in claim 12, wherein the strips are attached to the tube.

14. A vessel immobiliser projectile as claimed in claim 10, wherein the strips are of intrinsically stiffer material.

15. A vessel immobiliser projectile as claimed in claim 13, wherein the strips are attached directly by adhesive.

16. A vessel immobiliser projectile as claimed in claim 13, wherein the strips are accommodated in elongate pockets along the length of each tube, allowing for relative longitudinal movement of the strips and the pockets/tubes.

17. A vessel immobiliser projectile as claimed in claim 16, wherein the pockets are individual for individual strips.

18. A vessel immobiliser projectile as claimed in claim 17, wherein the pockets are formed by welding or adhesively securing thin strips of tube material onto the tubes.

19. A vessel immobiliser projectile as claimed in claim 17, wherein the pockets are narrow lay-flat tubes secured along the length of the main tubes.

20. A vessel immobiliser projectile as claimed in claim 17, wherein the pockets are provided between the main tubes and outer (or inner) additional sleeves enclosing (or enclosed within) the main sleeve.

21. A vessel immobiliser as claimed in claim 13, wherein each strip extends loose within its main tube.

22. A vessel immobiliser projectile as claimed in claim 1, wherein a single stiffening strip is provided for each tube.

23. A vessel immobiliser projectile as claimed in claim 1, wherein three stiffening strips are provided for each tube, one on one lay flat side and two on the other, the one fitting between the two when the tubes are flat and rolled for packing in the projectile.

24. A vessel immobiliser projectile as claimed in claim 1, wherein the means for inflating the tubes comprises a gas cylinder.

25. A vessel immobiliser projectile as claimed in claim 24, including a member soluble in water for gas release actuation of the inflation means.

26. A vessel immobiliser projectile as claimed in claim 1, including means for expelling the tube rolls from the casing.

27. A vessel immobiliser projectile as claimed in claim 26, wherein the expelling means is adapted and arranged to be activated by the inflation means extending an actuator to expel the tubes.

28. A vessel immobiliser projectile as claimed in claim 27, wherein the actuator is a piston and cylinder device.

29. A vessel immobiliser projectile as claimed in claim 27, wherein the actuator is a diaphragm device having a limited stroke.
